(19) United States
(12) Patent Application Publication
(10) Pub. No.: US 2004/0103858 A1
(43) Pub. Date: Jun. 3, 2004

(54) Shetley fuel economizer

(76) Inventor: Michael Shetley, Okeechobee, FL (US)

Correspondence Address: MCHALE & SLAVIN, P.A., 2855 PGA BLVD, PALM BEACH GARDENS, FL, 33410, US

(21) Appl. No.: 10/307,030

(22) Filed: Nov. 29, 2002

(51) Int. Cl. F02B 43/08

(52) U.S. Cl. 123/3

(57) ABSTRACT

The present invention provides a fractionating vaporized fuel system which provides a mixture of fresh air and vaporized lower boiling fractions of gasoline to the intake passage of an internal combustion engine. More specifically, the system uses hot engine coolant to vaporize the lower boiling fractions of a fuel such as gasoline for combustion as a vapor, and the higher boiling fractions are returned to the tank as a liquid for other uses. Intake air is heated by the exhaust manifold before being drawn through a vaporizing chamber and mixed with the vaporized fuel. The warm air/vaporized fuel mixture is then introduced to the engine prior to the choke plate of a carbureted or fuel injected engine. In this manner the vaporized fuel system is able to provide improved efficiency and reduced emissions throughout the entire range of engine requirements.

### FIELD OF THE INVENTION

The present invention relates to a fractionating vaporized fuel system which provides a mixture of fresh air and vaporized lower boiling fractions of gasoline to the intake passage of an internal combustion engine. More specifically, the system uses hot engine coolant to vaporize the lower boiling fractions of a fuel such as gasoline for combustion, and the higher boiling fractions are returned to the tank for other uses. Intake air is heated by the exhaust manifold before being drawn through a vaporizing chamber and mixed with the vaporized fuel. The warm air/vaporized fuel mixture is then introduced to the engine prior to the choke plate of a carbureted or fuel injected engine. In this manner the vaporized fuel system is able to provide improved efficiency and reduced emissions throughout the entire range of engine requirements.

### BACKGROUND OF THE INVENTION

Since the invention of the gasoline engine various attempts aimed at improving efficiency and reducing emissions of fuel systems have been made. It is well known in the prior art to improve combustion by atomizing liquid fuel for delivery to an internal combustion engine.

Carburetors or fuel injection are commonly used for atomizing liquid fuel for use in internal combustion engines. These devices use atomizing nozzles or jets to atomize the liquid fuel supplied to the engine. The small droplets of liquid fuel are then drawn into the cylinders of the engine for combustion. The atomized droplets of fuel do not burn completely and unburned fuel is discharged into the atmosphere as a pollutant.

It is also well known in the art that increasing the vaporization of the liquid fuel will overcome the problems discussed above. An engine operating entirely on vaporized fuel offers increased fuel economy and lower emissions over, an engine operating on liquid fuel. Increased vaporization can be accomplished in a number of ways, including various mechanical means such as screens. Other devices use heat to vaporize fuel. The prior art contains a substantial number of suggestions directed to vaporizing liquid fuels with heat for use in an internal combustion engine. Systems that use heat have generally centered around using exhaust gases, electrical elements, or hot radiator coolant as a source of heat for accomplishing vaporization.

Gasoline is generally comprised of various components such as Pentane, Hexane, Heptane, Octane, Nonane, Decane and Hendacane. These components vaporize at temperatures that range between 95° F. and 450° F. Even though it is well known in the art that the fractions of gasoline with the lowest boiling points generate lower emissions and generate higher gas milage per unit than the higher boiling fractions, a great deal of the prior art has concentrated on vaporizing or consuming all of the fractions of the gasoline. Systems that completely vaporize gasoline generally rely on the exhaust or electrical elements to achieve the required temperatures and are vulnerable to fire or explosion in the event of a malfunction.

Systems that utilize hot coolant or hot air are generally not capable of reaching the temperature required to completely vaporize the higher boiling fractions of gasoline. Instead these systems rely on the heat carried in the fuel to increase vaporization as the mixture of liquid/vapor pass through the carburetor or intake manifold. Other coolant heated systems separate and re-condenses the separated fractions. The lower boiling fractions are preferentially used as a liquid for start-up of the engine. After the engine has warmed up the higher boiling fractions of the gasoline are used as a liquid. This method offers reduced emissions and increased efficiency during warm-up. However, the fuel consumed after warm-up combusts poorly, causing spark knock and increased emissions when the majority of the fuel is consumed. Another coolant heated system exists which only consumes lower boiling fractions of gasoline as a vapor. This system requires expensive and complicated components to vaporize the fuel and feed vapors to the engine free of air. This method is likely to have operational problems meeting engine demands and may lack reliability required for daily vehicular use.

Accordingly, a safe and cost effective fractionating vaporized fuel system which provides a mixture of fresh air and vaporized lower boiling fractions of gasoline to the intake passage of an internal combustion engine for providing the economical and emission reduction benefits throughout the entire range of engine demands that can be easily installed on new as well as existing engines with minimal modification of the original fuel system would satisfy a long felt need in the art.

### DESCRIPTION OF THE PRIOR ART

A number of prior art devices exist for preheating or partially vaporizing fuel to improve combustion. Most of these devices use engine coolant to heat the fuel, while others use no heat and simply bubble air through the fuel. U.S. Pat. No. 4,003,356 discloses a closed vaporized fuel system for internal combustion engines in which no air is allowed to mix with the fuel prior to the carburetor. The system is directed at separating and delivering lower boiling fractions of vaporized fuel to the engine. The higher boiling fractions are drained out of the system and used for other applications. The system is comprised of a vaporizing chamber, a vacuum pump, and a filter. Presumably, fuel is wicked into the chamber and heated by hot water from the radiator which is circulated through a tube coiled within the chamber. A pump draws a vacuum on the chamber to promote vaporization. The vapor passing through the pump is pressurized and further processed through a filter to remove any remaining droplets of fuel before being delivered to the engine. This system requires an expensive vacuum pump to vaporize the fuel and a pressure pump to feed vapors to the engine free of air. This method also requires an additional filter apparatus to remove condensed fuel from the over-saturated vapor as it is pressurized. Due to the non-linearity of air pumps achieving the proper air/fuel mixture to meet engine demands would be difficult. There is also an unavoidable delay in processing the fuel vapor through the pump and filter which could cause poor throttle response during periods when quick acceleration is required.

U.S. Pat. No. 4,836,173 discloses a fuel vaporization device that attaches to the air cleaner housing of an engine. This device is aimed at providing only a portion of the air/fuel mixture consumed by the engine as a vapor. The carburetor provides the remainder of the air/fuel mixture consumed by the engine as an atomized liquid. The device consists of a small closed box with a fixed level of liquid fuel inside which is regulated by a float arrangement. Hot water is circulated through a heat conductive tube running tortuously through the box to heat the liquid fuel and the air above the fuel. Engine vacuum, an air pump or a fan is used to force air heated by the radiator through a tube located under the liquid fuel. The hot air exiting the tube forms bubbles that rise to the open space above the fuel forming an air/fuel mixture. The air/fuel mixture is then forced into the intake manifold for use by the engine. This device is only capable of supplementing the liquid fuel system and cannot provide enough vaporized fuel for complete operation of the engine. Moreover, this system consumes all fractions of the gasoline thereby reducing the overall gain in efficiency and reduction in emissions.

U.S. Pat. No. 4,594,991 discloses an apparatus for injecting a mixture of vaporized fuel, liquid fuel and steam into an engine's carburetor. This device is aimed at delivering a mixture of fuel vapor and water vapor to supplement the liquid fuel delivered by the carburetor. A portion of the fuel supplied by the fuel pump is diverted through a metering valve into a closed chamber where it is sprayed over a perforated vaporizer grid heated by a loop of copper tubing through which hot engine coolant is routed. Water is also passed through a tube within the chamber for preheating, and thereafter around the exhaust manifold where it is converted to steam. The steam is then mixed with the vaporized fuel as it enters the carburetor. This device is only capable of supplementing the liquid fuel system and cannot provide enough fuel vapors to operate the engine entirely from vaporized fuel. Moreover, this system consumes all fractions of the gasoline thereby reducing the overall gain in efficiency and reduction in emissions.

U.S. Pat. No. 6,119,637 discloses an on-board gasoline distillation system for reduced emissions at start-up. The device partially vaporizes the engine's primary fuel. The vapor is then condensed to a liquid and transferred to a second fuel tank. During initial start-up of the engine the secondary fuel is allowed to flow through the standard liquid fuel delivery system. After start-up the primary fuel is consumed. This type of system offers reduced emissions during the short warm-up cycle of the engine. However, all of the components of the fuel are still consumed after warm-up thereby reducing the overall gain in efficiency and reduction in emissions. Removing the high volatility components from the primary fuel results in poor combustion and higher emissions during the period when most of the fuel is consumed.

U.S. Pat. No. 4,798,191 discloses a fuel conditioning apparatus. This device is aimed at heating the fuel while it is in contact with polytetrafloroethylene (Teflon). The device circulates water from the engine through tubing within a container. The tubing and the inside of the container are coated with metal wool or fins to increase heat transfer to fuel passing through a tube coated with Teflon. The fuel is heated to a temperature below its vaporization point before being allowed to flow to the carburetor. The patent does not teach or suggest vaporizing fuel before it reaches the engine.

U.S. Pat. No. 5,218,944 discloses a fuel pre-heater for use with an internal combustion engine. The device concentrates on carefully controlling the preheated temperature of the fuel and requires the use of a microprocessor for constant regulation. Fuel on its way to the engine is split; one portion going to a heat exchanger and the rest going through a fuel cooler. The heat exchanger has a housing through which heated engine coolant on its way from the engine block to the radiator is routed. A coiled steel gas line is routed through the housing, and is connected between the regular fuel line and the engine. The fuel cooler uses the vehicles air conditioner to lower the temperature of the fuel. A computer-controlled valve proportionally mixes the heated fuel and the cooled fuel to create a fuel having a desired temperature before it is delivered to the fuel injection system. The patent does not teach or suggest vaporizing fuel before it reaches the engine.

U.S. Pat. No. 4,175,525 discloses a vaporization system which operates in parallel with a conventional carburetor system. The system is directed at allowing a small portion of the air entering the intake manifold to be bubbled through a pool of unheated gasoline. The system creates a small amount of vaporized fuel that is directly injected into the intake manifold downstream of the carburetor. A closed cylindrical canister utilizes a needle and seat arrangement to maintain the level of liquid fuel within the canister. When sufficient manifold vacuum is present, air is bubbled through the liquid fuel and drawn into the intake manifold of the engine. This device does not teach or suggest using engine coolant to vaporize lower boiling fractions of gasoline.

U.S. Pat. No. 6,155,239 discloses an unheated fuel evaporation system. The device is directed at replacing a carburetor or fuel injection system. The system uses the fuel tank to store fuel and generate fuel vapor for introduction to the intake manifold of the engine. Engine vacuum draws air through a bubble plate located in the bottom of the fuel tank. A computer and a series of sensors monitor and adjust the air/fuel ratio entering the engine as calculated by a computer.

None of the prior art devices suggest a fractionating vaporized fuel system which provides a mixture of fresh air and vaporized lower boiling fractions of gasoline to the intake passage of an internal combustion engine that can be easily installed on new as well as existing engines with minimal modification of the original fuel system.

### SUMMARY OF THE INVENTION

The present invention relates to a fractionating vaporized fuel system which provides a mixture of fresh air and vaporized lower boiling fractions of gasoline to the intake passage of an internal combustion engine. In operation, the vehicle is started using its conventional liquid fuel system. The engine produces a vacuum in the intake air passage and atmospheric air begins to flow through the vapor chamber. The device consists of a vaporizing container with a relatively constant level of liquid fuel inside which is regulated by a float arrangement. Hot water is circulated through a heat conductive heater core which extends the length and width of the container to heat the liquid fuel and the air above the fuel. Engine vacuum draws fresh air across an air-to-air heat exchanger preheating it before it flows into the vaporizing chamber. A small amount of incoming air is allowed to flow through a bubble plate under the liquid fuel to create agitation. The lower boiling fractions of gasoline are vaporized and rise to the area above the liquid fuel. The pre-heated incoming air mixes with the vaporized fuel, and then flows out of the chamber and into the intake air passage of the engine for combustion. As the fuel reaches the combustion chamber the vehicles on board sensors reduce the flow of liquid fuel being injected into the engine and the engine operates primarily using vaporized fuel. Should the engine need additional fuel the liquid fuel system can provide a response. This system can thereby provide improved fuel economy and reduced emissions over vehicles operating on all fractions of liquid fuel. Fuel that does not vaporize flows back to the fuel tank and recycles through the vapor chamber. In a non-limiting embodiment, when all of the lower boiling fractions of gasoline have been removed from the fuel, the high boiling fractions may be removed from the tank and used for other applications.

Accordingly, it is an objective of the present invention to provide a fractionating vaporized fuel system which provides a mixture of fresh air and vaporized lower boiling fractions of gasoline to the intake passage of an internal combustion engine capable of providing a combination air/vaporized fuel mixture based on engine demands.

It is a further objective of the present invention to provide a fractionating vaporized fuel system which provides a mixture of fresh air and vaporized lower boiling fractions of gasoline to the intake passage of an internal combustion engine that requires minimal modifications to the factory fuel system.

It is another objective of the present invention to provide a fractionating vaporized fuel system which provides a mixture of fresh air and vaporized lower boiling fractions of gasoline to the intake passage of an internal combustion engine capable of providing a combination air/vaporized fuel mixture based on engine demands that can be installed on existing as well as new vehicles.

It is another objective of the present invention to provide a kit for a fractionating vaporized fuel system which provides a mixture of fresh air and vaporized lower boiling fractions of gasoline to the intake passage of an internal combustion engine capable of providing a combination air/vaporized fuel mixture based on engine demands which is simple to install and which is ideally suited for original equipment and aftermarket installations.

It is yet another objective of the present invention to provide a kit for a fractionating vaporized fuel system which provides a mixture-of fresh air and vaporized lower boiling fractions of gasoline to the intake passage of an internal combustion engine capable of providing a combination air/vaporized fuel mixture based on engine demands that can be inexpensively manufactured and which is simple and reliable in operation.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 illustrates schematically the internal combustion engine of a vehicle, fuel being supplied to the engine by a fractionating vapor fuel system in accordance with the present invention;

FIG. 2 is a perspective view of the vaporizing canister of the present invention a portion thereof being broken away;

FIG. 3 is an section view along line 1-1 of FIG. 1 illustrating the vapor chamber of the present invention.

### DETAILED DESCRIPTION OF THE INVENTION

Although the invention is described in terms of a preferred specific embodiment, it will be readily apparent to those skilled in this art that various modifications, rearrangements and substitutions can be made without departing from the spirit of the invention. The scope of the invention is defined by the claims appended hereto.

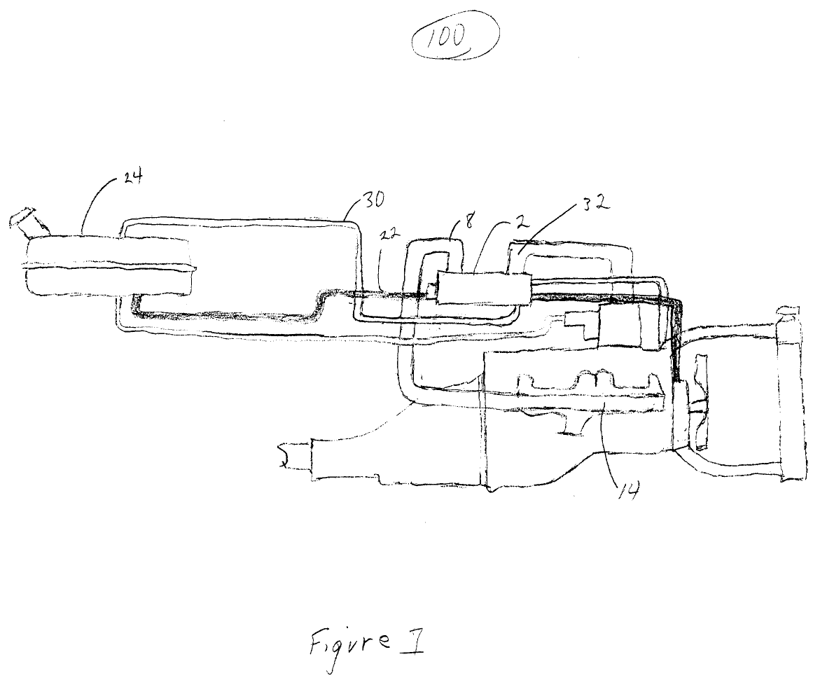

In order to alleviate the emissions problems associated with operating an internal combustion engine, the present invention utilizes a fractionating vapor fuel system 100 as set forth in FIG. 1.

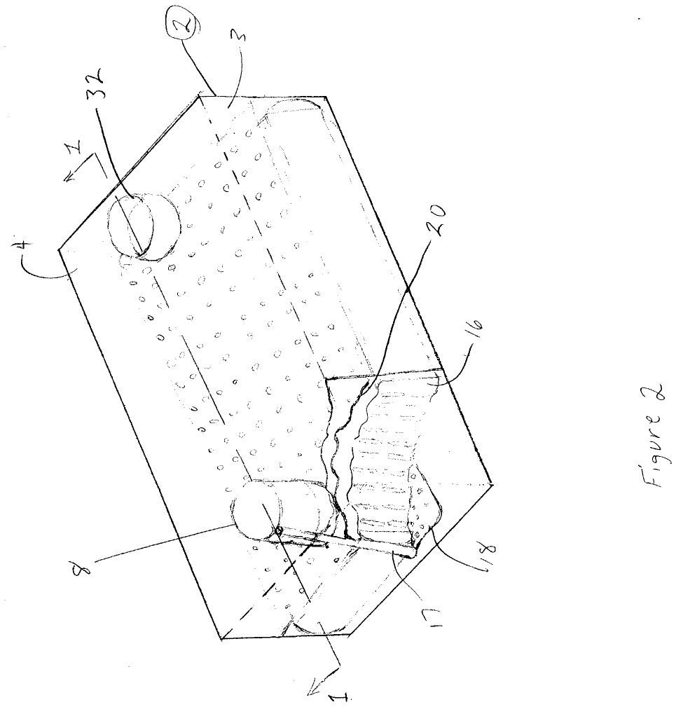

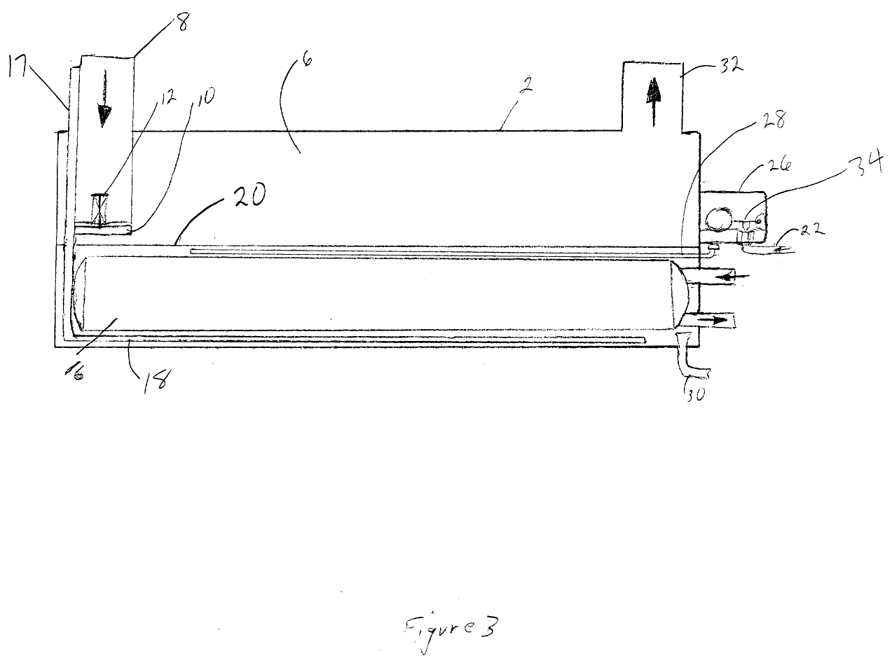

In accordance with FIGS. 1 through 3, the fuel vaporizer canister 2 is generally a rectangular-shaped box with a sealed removably attached lid 4. The bottom portion 3 of the canister 2 is constructed having a generally flat bottom surface and four sealably attached upstanding walls. The lid 4 and the bottom portion 3 are removably and sealably joined to form a sealed enclosure surrounding an interior chamber 6. Generally the volume of interior vapor chamber 6 should be of suitable size to produce enough vapor to operate the desired engine and still fit within the engine compartment of the vehicle. In the preferred embodiment the volume of the vapor chamber 6 is approximately 240 cubic inches. The vaporizing canister 2 is preferably constructed of aluminum but may be constructed of other suitable materials well known in the art capable of withstanding contact with fuel and capable of adequate heat resistance. The vaporizing canister is provided with a liquid fuel regulating means which is in fluid communication with the fuel tank 24 via conduit 22. The fuel regulating means is illustrated as a needle and valve seat arrangement 34 controlled by a float. The needle is adapted to mate with the valve seat and thereby obstruct the flow of fluid through the valve seat in either direction when the needle is positioned within the valve seat. Other suitable devices well known in the art that are capable of delivering a relatively constant volume of fluid could be used as a fuel regulating means. A rectangular shield 26 is removably and sealably attached to an upstanding wall of the vaporizing canister for enclosing the needle and seat arrangement. The shield 26 should be constructed and arranged to protect the float from undesired agitation from fuel splash. The needle and seat arrangement controls fuel flow into the vapor chamber 6 through fuel tube 28. The fuel tube 28 has a plurality of cross drilled openings and extends across the top of the heater core 16 and under a perforated plate 20. Fuel exiting the drilled openings (not shown) is allowed to drip downwardly across the heater core 16 to the bottom of the vapor chamber 6. In the preferred embodiment the return line 30 is adjusted to protrude above the bottom surface of vapor chamber 6 about ¼ to ½ inch. Fuel that is not vaporized is allowed to return to the fuel tank through return line 30. In this manner the float, needle and seat arrangement maintains a predetermined level of liquid fuel within the vapor chamber 6.

Means are provided to continuously heat both the liquid fuel and the air space above the fuel within the canister 2 using engine coolant. For this purpose a heater core 16 is preferably located about ⅛ inch above the bottom surface of the vapor chamber 6 and partially submerged within the liquid fuel. Hot coolant on its way from the engine block to the radiator is forced through the heater core 16 by the water pump and returned to the coolant system.

The perforated plate 20 is mounted above the heater core 16 within the vapor chamber 6 and extends across the chamber to substantially form a false bottom. The perforated plate 20 should be mounted close enough to the heater core 16 to transfer heat to the air above the liquid fuel within the vapor chamber 6. In the preferred embodiment the perforated plate 20 is mounted about ¼ inch above the heater core 16.

A Pre-heater means, shown as an air-to-air heat exchanger 14 heated by the exhaust manifold of the engine pre-heats air flowing into the vapor chamber 6. The heated air enters the intake passage 8 that is removably and sealably attached to the canister lid 4. The intake passage 8 is blocked by a resilient disk 10 which is held in place by a coil spring 12. The disk 10 therefore blocks the intake passage 8 to prevent the backward flow of fluid from the vapor canister 2 but allows fluid to flow toward the engine when the pressure differential across the disk is sufficient to overcome the spring 12. The diameter of the intake passage 8 is preferably about 2 inches, but should be determined by the displacement of the engine. Very large displacement engines may require a larger intake passage while smaller engines may be able to use a smaller passage. This can be determined by routine experimentation. A portion of the air entering the vapor chamber is allowed to flow downwardly through tube 17 to a bubble plate 18 located adjacent to the bottom surface of the vapor chamber 6. The air exiting the bubble plate agitates the liquid fuel as it rises upwardly.

An air/vapor outlet passage 32, removably and sealably attached to the canister lid 4, is in fluid communication with the intake air passage of the engine so that during engine operation substantially all of the air consumed by the engine is drawn through the vapor chamber 6. The diameter of the air/vapor outlet passage 32 is preferably about 2 inches, but should be determined by the displacement of the engine. Very large displacement engines may require a larger intake passage while smaller engines may be able to use a smaller passage. This can be determined by routine experimentation.

Since the circulating coolant fluid is introduced to the vapor chamber 6 at a temperature of, for example 195° F. And since the liquid gasoline consists of various mixtures of gasoline components which vaporize within a range of 95° F. for Pentane to about 450° F. for Hendacane, the higher volatility components of the gasoline will vaporize as the gasoline flows through the vapor chamber 6, while the non-vaporized fuel will be returned to the fuel tank 24. The volatile fuel mixes with pre-heated air passing through the chamber and is drawn to the engine for combustion. The higher boiling less volatile fractions of the gasoline can be drained from the fuel tank and used for other applications.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

What is claimed is:

1. A fractionating vapor fuel system which provides a mixture of fresh air and vaporized lower boiling fractions of gasoline to the intake passage of an internal combustion engine, wherein a high volatility fuel is substantially supplied as a vapor after engine warm-up, comprising:
a liquid fuel supply, wherein said fuel exists in the liquid state at normal atmospheric pressures and temperatures;
a means for delivering liquid fuel from said liquid fuel supply to a means for supplying low boiling fractions of vaporized fuel, said means for delivering liquid fuel in liquid communication with said fuel supply;
a means for supplying low boiling fractions of vaporized fuel to said engine, said means for supplying low boiling fractions of vaporized fuel in fluid communication with said liquid fuel supply.

2. The fractionating vapor fuel system as set forth in claim 1, wherein said means for supplying vaporized fuel comprises:
a vaporizer canister, said vaporizer canister having an internal vapor chamber, said canister also having a intake air passage and a air/vapor outlet passage;
a liquid fuel regulating means for controlling liquid fuel flowing through said vaporizing chamber, said liquid fuel regulating means constructed and arranged for removable attachment to said vaporizer canister, said liquid fuel regulating means in fluid communication with said liquid fuel supply.
a heating means for heating the liquid fuel and the air above the liquid fuel within said vapor chamber, said heater means sealably and removably attached within said canister, said heater means in fluid communication with the coolant system of said engine;

3. The fractionating vapor fuel system as set forth in claim 2, wherein said liquid fuel regulating means comprises:
a needle and valve seat arrangement controlled by a float, wherein said needle is adapted to mate with said valve seat to obstruct the flow of liquid fuel through the valve seat in either direction when said needle is positioned within said valve seat.

4. The fractionating vapor fuel system as set forth in claim 2, wherein said liquid fuel regulating means comprises:
a metering valve, said metering valve constructed and arranged to adjustably control the flow of liquid fuel flowing through said vaporizing chamber.

5. The fractionating vapor fuel system as set forth in claim 2, wherein said heating means comprises:
a heater core, said heater core constructed and arranged to provide heat to said liquid fuel and air above said liquid fuel within said vapor chamber for vaporization of said lower boiling fractions of gasoline, said heater core in fluid communication with said coolant system of said engine.

6. The fractionating vapor fuel system as set forth in claim 2, wherein said intake passage of said vaporizing canister further comprises:
a resilient disk, said resilient disk held in place by a coil spring, said resilient disk constructed and arranged to prevent the backward flow of fluid from said vapor canister, but allowing fluid to flow toward said engine when the pressure differential across said disk is sufficient to overcome said spring.

7. The fractionating vapor fuel system as set forth in claim 2, wherein said intake passage of said vaporizing canister is at least about two inches in diameter.

8. The fractionating vapor fuel system as set forth in claim 2, wherein said air/vapor outlet passage of said vaporizing canister is at least about two inches in diameter.

9. The fractionating vapor fuel system as set forth in claim 2, wherein said mixture of fresh air and vaporized lower boiling fractions of gasoline are introduced to the intake passage of an internal combustion engine prior to the choke plate of said engine.

10. The fractionating fuel vapor system as set forth in claim 1 further comprising:
an air pre-heater means, said pre-heater means constructed and arranged to increase the ambient temperature of said fresh air entering said means for supplying low boiling fractions of vaporized fuel to said engine.

11. A kit for a fractionating vapor fuel system which provides a mixture of fresh air and vaporized lower boiling fractions of gasoline to the intake passage of an internal combustion engine, wherein a high volatility fuel is substantially supplied as a vapor after engine warm-up, comprising:
a liquid fuel supply, wherein said fuel exists in the liquid state at normal atmospheric pressures and temperatures;
a means for delivering liquid fuel from said liquid fuel supply to a means for supplying low boiling fractions of vaporized fuel, said means for delivering liquid fuel in liquid communication with said fuel supply;
a means for supplying low boiling fractions of vaporized fuel to said engine, said means for supplying low boiling fractions of vaporized fuel in fluid communication with said liquid fuel supply.

12. The fractionating vapor fuel system kit as set forth in claim 11, wherein said means for supplying vaporized fuel comprises:
a vaporizer canister, said vaporizer canister having an internal vapor chamber, said canister also having a intake air passage and a air/vapor outlet passage;
a liquid fuel regulating means for controlling liquid fuel flowing through said vaporizing chamber, said liquid fuel regulating means constructed and arranged for removable attachment to said vaporizer canister, said liquid fuel regulating means in fluid communication with said liquid fuel supply.
a heating means for heating the liquid fuel and the air above the liquid fuel within said vapor chamber, said heater means sealably and removably attached within said canister, said heater means in fluid communication with the coolant system of said engine;

13. The fractionating vapor fuel system kit as set forth in claim 12, wherein said liquid fuel regulating means comprises:
a needle and valve seat arrangement controlled by a float, wherein said needle is adapted to mate with said valve seat to obstruct the flow of liquid fuel through the valve seat in either direction when said needle is positioned within said valve seat.

14. The fractionating vapor fuel system kit as set forth in claim 12, wherein said liquid fuel regulating means comprises:
a metering valve, said metering valve constructed and arranged to adjustably control the flow of liquid fuel flowing through said vaporizing chamber.

15. The fractionating vapor fuel system kit as set forth in claim 12, wherein said heating means comprises:
a heater core, said heater core constructed and arranged to provide heat to said liquid fuel and air above said liquid fuel within said vapor chamber for vaporization of said lower boiling fractions of gasoline, said heater core in fluid communication with said coolant system of said engine.

16. The fractionating vapor fuel system kit as set forth in claim 12, wherein said intake passage of said vaporizing canister further comprises:
a resilient disk, said resilient disk held in place by a coil spring, said resilient disk constructed and arranged to prevent the backward flow of fluid from said vapor canister, but allowing fluid to flow toward said engine when the pressure differential across said disk is sufficient to overcome said spring.

17. The fractionating vapor fuel system kit as set forth in claim 12, wherein said intake passage of said vaporizing canister is at least about two inches in diameter.

18. The fractionating vapor fuel system kit as set forth in claim 12, wherein said air/vapor outlet passage of said vaporizing canister is at least about two inches in diameter.

19. The fractionating vapor fuel system kit as set forth in claim 12, wherein said mixture of fresh air and vaporized lower boiling fractions of gasoline are introduced to the intake passage of an internal combustion engine prior to the choke plate of said engine.

20. The fractionating fuel vapor system as set forth in claim 1 further comprising:
an air pre-heater means, said pre-heater means constructed and arranged to increase the ambient temperature of said fresh air entering said means for supplying low boiling fractions of vaporized fuel to said engine.
